(19) United States
(12) Patent Application Publication
(10) Pub. No.: US 2004/0157740 A1
(43) Pub. Date: Aug. 12, 2004

(54) Heterocyclyl phenyl benzyl ethers used as fungicides

(76) Inventors: Fritz Maurer, Monheim (DE); Ulrich Heinemann, Leichlingen (DE); Bernd-Wieland Kruger, Bergisch Gladbach (DE); Herbert Gayer, Monheim (DE); Christiane Boie, Leichlingen (DE); Astrid Mauler-Machnik, Leichlingen (DE); Ulrike Wachendorff-Neumann, Neuwied (DE)

Correspondence Address: BAYER CROPSCIENCE LP, Patent Department, 100 BAYER ROAD, PITTSBURGH, PA, 15205-9741, US

(21) Appl. No.: 10/477,487

(22) PCT Filed: May 2, 2002
(86) PCT No.: PCT/EP02/04789

(30) Foreign Application Priority Data
May 15, 2001 (DE) 10123484.8

(51) Int. Cl. A01N 43/54; A01N 43/40; A01N 43/76; A01N 43/82

(52) U.S. Cl. 504/243; 504/244; 504/251; 504/265; 504/263; 504/266; 504/270; 544/333; 546/329; 548/131; 548/134; 548/203; 548/235; 548/252

(57) ABSTRACT

The invention relates to novel heterocyclylphenyl benzyl ethers, to a process for their preparation and to their use for controlling harmful organisms.

The invention relates to novel heterocyclylphenyl benzyl ethers, to a process for their preparation and to their use for controlling harmful organisms.

Certain compounds having a similar substitution pattern and their fungicidal action are already known (compare, for example, WO 95/04728, WO 99/46246, WO 97/14693, WO 00/53585). However, in particular at low application rates and concentrations, the activity of these prior-art compounds is not in all areas of use entirely satisfactory.

The present invention provides the novel heterocyclylphenyl benzyl ethers of the general formula (I)

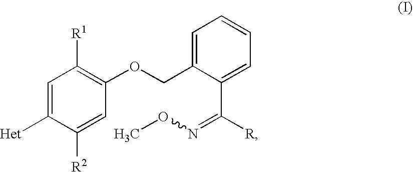

in which

R represents methoxycarbonyl, methylaminocarbonyl or represents 5,6-dihydro-1,4,2-dioxazin-3-yl,

R¹ represents alkyl,

R² represents hydrogen or aryl and

Het represents optionally substituted tetrazolyl, 1,2,4-oxadiazolyl, 1,3,4-oxadiazolyl, 1,3,4-thiadiazolyl, 1,3-oxazolyl, 1,3-thiazolyl, pyridyl or pyrimidyl.

For the definitions of the symbols given in the formulae, collective terms are used which represent the following substituents in a general manner:

Halogen: fluorine, chlorine, bromine and iodine, in particular fluorine or chlorine; alkyl: saturated, straight-chain or branched hydrocarbon chains, unless indicated otherwise preferably hydrocarbon chains having 1 to 6 carbon atoms, such as methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl and 1-ethyl-2-methylpropyl;

haloalkyl: straight-chain or branched alkyl groups having 1 to 4 carbon atoms (as mentioned above), where in these groups some or all of the hydrogen atoms may be replaced by halogen atoms as mentioned above, for example C₁-C₂-haloalkyl such as chloromethyl, dichloromethyl, trichloromethyl, fluoromethyl, difluoromethyl, trifluoromethyl, chlorofluoromethyl, dichlorofluoromethyl, chlorodifluoromethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl and pentafluoroethyl;

alkoxy: straight-chain or branched alkyl groups having 1 to 4 or 10 carbon atoms (as mentioned above) which are attached to the skeleton via an oxygen atom (—O—);

alkenyl: unsaturated, straight-chain or branched hydrocarbon radicals having 2 to 10 carbon atoms and a double bond in any position, for example C₂-C₆-alkenyl, such as ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl and 1-ethyl-2-methyl-2-propenyl;

alkynyl: straight-chain or branched hydrocarbon groups having 2 to 10 carbon atoms and a triple bond in any position, for example C₂-C₆-alkynyl, such as ethynyl, 1-propynyl, 2-propynyl, 1-butynyl, 2-butynyl, 3-butynyl, 1-methyl-2-propynyl, 1-pentynyl, 2-pentynyl, 3-pentynyl, 4-pentynyl, 1-methyl-2-butynyl, 1-methyl-3-butynyl, 2-methyl-3-butynyl, 3-methyl-1-butynyl, 1,1-dimethyl-2-propynyl, 1-ethyl-2-propynyl, 1-hexynyl, 2-hexynyl, 3-hexynyl, 4-hexynyl, 5-hexynyl, 1-methyl-2-pentynyl, 1-methyl-3-pentynyl, 1-methyl-4-pentynyl, 2-methyl-3-pentynyl, 2-methyl-4-pentynyl, 3-methyl-1-pentynyl, 3-methyl-4-pentynyl, 4-methyl-1-pentynyl, 4-methyl-2-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl and 1-ethyl-1-methyl-2-propynyl.

Furthermore, it has been found that the novel heterocyclylphenyl benzyl ethers of the general formula (I) are obtained when

a) benzyl halides of the formula (II)

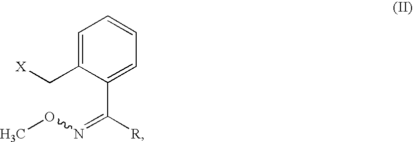

in which

R is as defined above and

x represents halogen

are reacted with a substituted phenol of the general formula (III)

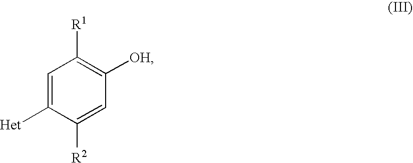

in which

R¹, R² and Het are as defined above,

if appropriate in the presence of a diluent and if appropriate in the presence of an acid acceptor, or when

b) heterocyclylphenyl benzyl ethers of the formula (I) where R is methoxycarbonyl are reacted with methylamine, if appropriate in the presence of a diluent, or when

c) benzyloxyphenylnitriles of the general formula (IV)

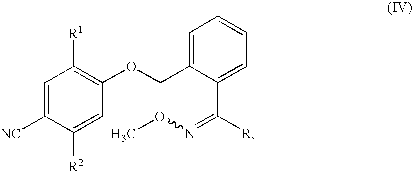

in which

R, R¹ and R² are as defined above,

are reacted with an alkali metal azide, if appropriate in the presence of a diluent, or when

d) heterocyclylphenyl benzyl ethers of the formula (I) where Het is tetrazolyl are reacted with alkylating agents, such as, for example, iodomethane, dimethyl sulfate or bromoethane, if appropriate in the presence of a diluent and if appropriate in the presence of an acid acceptor.

Finally, it has been found that the novel heterocyclylphenyl benzyl ethers of the general formula (I) are highly active against harmful organisms and have, in particular, pronounced fungicidal action. Harmful organisms are to be understood as meaning, in particular, microorganisms and animal pests.

If appropriate, the compounds according to the invention can be present as mixtures of different possible isomeric forms, in particular of stereoisomers, such as, for example, E and Z. What is claimed are both the E and the Z isomers and any mixtures of these isomers.

R preferably represents methoxycarbonyl, methylaminocarbonyl or represents 5,6-dihydro-1,4,2-dioxazin-3-yl.

R¹ preferably represents alkyl having 1 to 4 carbon atoms.

R² preferably represents hydrogen or alkyl having 1 to 4 carbon atoms.

Het preferably represents tetrazolyl which is optionally substituted by alkyl having 1 to 4 carbon atoms, haloalkyl having 1 to 4 carbon atoms and 1 to 9 halogen atoms, alkenyl or aleynyl having in each case 2 to 4 carbon atoms.

Het also preferably represents 1,2,4-oxadiazolyl, 1,3,4-oxadiazolyl, 1,3,4-thiadiazolyl, 1,3-oxazolyl, 1,3-thiazolyl, optionally substituted by alkyl or alkoxy having in each case 1 to 4 carbon atoms, haloalkyl having 1 to 4 carbon atoms and 1 to 9 halogen atoms, alkenyl or alkynyl having in each case 2 to 4 carbon atoms.

Het also preferably represents pyridyl or pyrimidyl, optionally substituted by halogen, alkyl or alkoxy having in each case 1 to 4 carbon atoms, haloalkyl having 1 to 4 carbon atoms and 1 to 9 halogen atoms, alkenyl or alkynyl having in each case 2 to 4 carbon atoms.

R particularly preferably represents methoxycarbonyl, methylaminocarbonyl or represents 5,6-dihydro-1,4,2-dioxazin-3-yl.

R¹ particularly preferably represents methyl.

R² particularly preferably represents hydrogen or methyl.

Het particularly preferably represents tetrazolyl which is optionally substituted by methyl, ethyl, n- or i-propyl, n-, i-, s- or t-butyl, difluoromethyl, trifluoromethyl, allyl or propargyl.

Het also particularly preferably represents 1,2,4-oxadiazolyl, 1,3,4-oxadiazolyl, 1,3,4-thiadiazolyl, 1,3-oxazolyl or 1,3-thiazolyl, optionally substituted by methyl, ethyl, n- or i-propyl, n-, i-, s- or t-butyl, methoxy, ethoxy, difluoromethyl, trifluoromethyl, allyl or propargyl.

Het also particularly preferably represents pyridyl or pyrimidyl, optionally substituted by fluorine, chlorine, bromine, methyl, ethyl, n- or i-propyl, n-, i-, s- or t-butyl, methoxy, ethoxy, difluoromethyl, trifluoromethyl, allyl or propargyl.

The abovementioned general or preferred radical definitions apply both to the end products of the formula (1) and, correspondingly, to the starting materials or intermediates required in each case for the preparation.

The particular radical definitions given in the respective combinations and preferred combinations of radicals for these radicals are, independently of the combination of radicals given in each case, also replaced by any radical definitions of other preferred ranges.

The formula (II) provides a general definition of benzyl halides required as starting materials for carrying out the process a) according to the invention. In this formula (II), R preferably or in particular has that meaning which has already been given in connection with the description of the compounds of the formula (I) according to the invention as being preferred or as being particularly preferred for R. X represents halogen, preferably chlorine or bromine.

The starting materials of the formula (II) are known and can be prepared by known processes (compare, for example, WO 99/46263, WO 99/19311, WO 98/17653, WO 97/21686, WO 96/07635, EP 254 426).

The formula (III) provides a general definition of the substituted phenols furthermore required as starting materials for carrying out the process a) according to the invention. In this formula (I), R¹, R² and Het preferably or in particular have those meanings which have already been mentioned in connection with the description of the compounds of the formula (I) according to the invention as being preferred or as being particularly preferred for R¹, R² and Het.

The starting materials of the formula (III) are novel and also form part of the subject-matter of the present application.

They are obtained when

e) alkoxyphenols of the general formula (V)

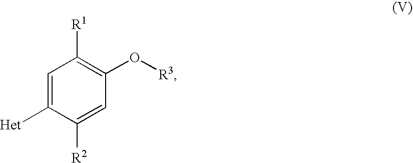

in which

R¹, R² and Het are as defined above and

R³ represents alkyl or optionally substituted benzyl

are reacted in the presence of a Lewis acid, such as, for example, boron tribromide, if appropriate in the presence of a diluent, such as, for example, methylene chloride.

The formula (V) provides a general definition of the alkoxyphenols required as starting materials for carrying out the process e) according to the invention. In this formula (V), R¹, R² and Het preferably or in particular have those meanings which have already been mentioned in connection with the description of the compounds of the formula (I) according to the invention as being preferred or as being particularly preferred for R¹, R² and Het. R³ represents alkyl or optionally substituted benzyl, preferably methyl, ethyl, benzyl or chlorobenzyl.

The starting materials of the formula (V) are novel and also form part of the subject-matter of the present application.

They are obtained when

f) benzonitriles of the formula (VI)

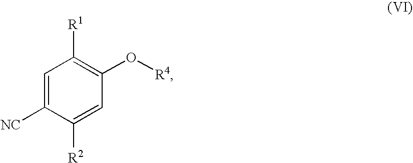

in which

R¹ and R² are as defined above, and

R⁴ represents hydrogen or alkyl

are reacted with an alkali metal azide, such as, for example, sodium azide, if appropriate in the presence of a diluent, such as, for example, dimethylformamide, and if appropriate in the presence of a further reaction auxiliary, or when

g) amidoximes of the formula (VII)

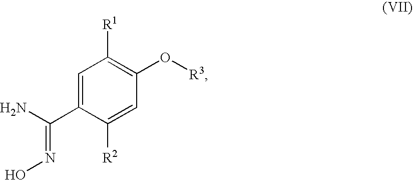

in which

R¹, R² and R³ are as defined above

are reacted with an orthoester of the formula (VM)

R⁴—C(OR⁵)₃ (VIII),

in which

R⁴ represents alkyl and

R⁵ represents alkyl,

if appropriate in the presence of a diluent, or when

h) boron acids of the formula (IX)

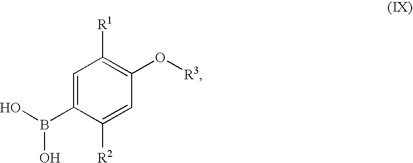

in which

R¹, R², and R³ are as defined above

are reacted with a haloheterocycle of the formula (X)

Het-Y (X)

in which

Het is as defined above and

Y represents halogen,

if appropriate in the presence of a diluent, such as, for example, dimethoxyethane, if appropriate in the presence of a catalyst, preferably a palladium complex, such as, for example, tetrakis(triphenylphosphine)palladium(0), if appropriate in the presence of an acid acceptor, such as, for example, aqueous sodium carbonate solution, or when

i) alkoxyphenols of the general formula (V) where Het is tetrazolyl are reacted with alkylating agents, such as, for example, iodomethane, dimethyl sulfate or bromoethane, if appropriate in the presence of a diluent, such as, for example, acetonitrile, and if appropriate in the presence of an acid acceptor, such as, for example, potassium carbonate.

R⁴ and R⁵ preferably represent C₁-C₄-alkyl.

R⁴ and R⁵ particularly preferably represent methyl or ethyl.

The formula (VI) provides a general definition of the benzonitriles required as starting materials for carrying out the process f) according to the invention. In this formula (VI), R¹, R² and R³ preferably or in particular have those meanings which have already been mentioned in connection with the description of the compounds of the formula (V) according to the invention as being preferred or as being particularly preferred for R¹, R² and R³.

The starting materials of the formula (VI) are known and can be prepared by known processes (compare, for example, U.S. Pat. No. 5,464,848).

The alkali metal azides furthermore required as starting materials for carrying out the process f) according to the invention are commercially available chemicals for synthesis.

The formula (VII) provides a general definition of the amidoximes required as starting materials for carrying out the process g) according to the invention. In this formula (VII), R¹, R² and R³ preferably or in particular have those meanings which have already been mentioned in connection with the description of the compounds of the formula (V) according to the invention as being preferred or as being particularly preferred for R¹, R² and R³.

They are obtained (process j) when alkoxybenzonitriles of the formula (VI), which have already been described in connection with process f), are reacted with hydroxylamine or acid addition complexes thereof, if appropriate in the presence of a diluent.

Hydroxylamine and its salts are commercially available chemicals for synthesis.

The formula (VIII) provides a general definition of the orthoesters furthermore required as starting materials for carrying out the process g) according to the invention. In this formula (VII), R⁴ represents alkyl, preferably methyl or ethyl, and R⁵ represents alkyl, preferably methyl or ethyl.

The orthoesters of the formula (VII) are commercially available chemicals for synthesis.

The formula (IX) provides a general definition of the boronic acids required as starting materials for carrying out the process h) according to the invention. In this formula (IX), R¹, R² and R³ preferably or in particular have those meanings which have already been mentioned in connection with the description of the compounds of the formula (V) according to the invention as being preferred or as being particularly preferred for R¹, R² and R³.

Process h) boronic acids of the formula (IX) are known and can be prepared by known methods (compare, for example, WO 96/16934 or WO 99/51568).

The formula (X) provides a general definition of the haloheterocycles furthermore required as starting materials for carrying out the process h) according to the invention. In this formula (X), Y represents halogen, preferably chlorine or bromine.

Haloheterocycles of the formula (X) are known and can be prepared by known methods (compare, for example, DE 3228147).

The alkoxyphenols of the general formula (V) where Het is tetrazolyl required as starting materials for carrying out the process i) according to the invention can be prepared according to process f).

The alkylating agents, such as, for example, iodomethane, dimethyl sulfate or bromoethane, furthermore required as starting materials for carrying out the process i) according to the invention are commercially available chemicals for synthesis.

The heterocyclylphenyl benzyl ethers of the formula (I) where R is methoxycarbonyl required as starting materials for carrying out the process b) according to the invention are compounds according to the invention and can be prepared according to process a), c) or d).

Methylamine, furthermore required as starting material for carrying out the process b) according to the invention, is a commercially available chemical for synthesis.

The formula (IV) provides a general definition of the benzyloxyphenylnitriles required as starting materials for carrying out the process c) according to the invention. In this formula (IV), R, R¹ and R² preferably or in particular have those meanings which have already been mentioned in connection with the description of the compounds of the formula (1) according to the invention as being preferred or as being particularly preferred for R, R¹ and R².

The benzyloxyphenylnitriles of the general formula (IV) have hitherto not been disclosed and, as novel substances, also form part of the subject-matter of the present invention.

They can be obtained (process k) when hydroxybenzonitriles of the formula (XI)

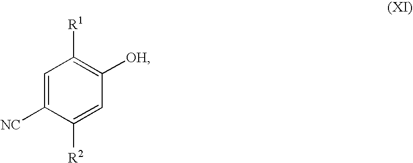

in which

R¹ and R² are as defined above

are reacted with the benzyl halides of the formula (II), described in connection with process a), if appropriate in the presence of a diluent, such as, for example, acetonitrile, and if appropriate in the presence of an acid acceptor, such as, for example, potassium carbonate.

The formula (XI) provides a general definition of the hydroxybenzonitriles required as starting materials for carrying out the process k) according to the invention. In this formula (VI), R¹ and R² preferably or in particular have those meanings which have already been mentioned in connection with the description of the compounds of the formula (I) according to the invention as being preferred or as being particularly preferred for R¹ and R².

The starting materials of the formula (XI) are known and can be prepared by known processes (compare, for example, U.S. Pat. No. 5,464,848).

The heterocyclylphenyl benzyl ethers of the formula (1) where Het is tetrazolyl, required as starting materials for carrying out the process d) according to the invention, are compounds according to the invention and can be obtained by process a) or c).

The alkylating agents, such as, for example, iodomethane, dimethyl sulfate or bromoethane, furthermore required as starting materials for carrying out the process d) according to the invention, are commercially available chemicals for synthesis.

Suitable diluents for carrying out the processes a) and d) according to the invention are all inert organic solvents. These preferably include aliphatic, alicyclic or aromatic hydrocarbons, such as, for example, petroleum ether, hexane, heptane, cyclohexane, methylcyclohexane, benzene, toluene, xylene or decalin; halogenated hydrocarbons, such as, for example, chlorobenzene, dichlorobenzene, dichloromethane, chloroform, carbon tetrachloride, dichloroethane or trichloroethane; ethers, such as diethyl ether, diisopropyl ether, methyl t-butyl ether, methyl t-amyl ether, dioxane, tetrahydrofuran, 1,2-dimethoxyethane, 1,2-diethoxyethane or anisole; ketones, such as acetone, butanone, methyl isobutyl ketone or cyclohexanone; nitriles, such as acetonitrile, propionitrile, n- or i-butyronitrile or benzonitrile; amides, such as N,N-dimethylformamide, N,N-dimethylacetamide, N-methylformanilide, N-methylpyrrolidone or hexamethylphosphoric triamide; esters, such as methyl acetate or ethyl acetate; sulfoxides, such as diniethyl sulfoxide; sulfones, such as sulfolane; alcohols, such as methanol, ethanol, n- or i-propanol, n-, i-, sec- or tert-butanol, ethanediol, propane-1,2-diol, ethoxyethanol, methoxyethanol, diethylene glycol monomethyl ether, diethylene glycol monoethyl ether, mixtures thereof with water or pure water.

The processes a) and d) according to the invention are, if appropriate, carried out in the presence of a suitable acid acceptor. Suitable acid acceptors are all customary inorganic or organic bases. These preferably include alkaline earth metal or alkali metal hydrides, hydroxides, amides, alkoxides, carbonates or bicarbonates, such as, for example, sodium hydride, sodium amide, sodium methoxide, sodium ethoxide, potassium tert-butoxide, sodium hydroxide, potassium hydroxide, sodium carbonate, potassium carbonate, potassium bicarbonate or sodium bicarbonate, and also tertiary amines, such as trimethylamine, triethylamine, tributylamine, N,N-dimethylaniline, N,N-dimethylbenzylamine, pyridine, N-methylpiperidine, N-methylmorpholine, N,N-dimethylaminopyridine, diazabicyclooctane (DABCO), diazabicyclononene (DBN) or diazabicycloundecene (DBU).

When carrying out the processes a) and d) according to the invention, the reaction temperatures can be varied within a relatively wide range. In general, the processes are carried out at temperatures of from 0° C. to 150° C., preferably at temperatures of from 20° C. to 80° C.

For carrying out the process a) according to the invention for preparing the compounds of the formula (1), in general from 0.2 to 5 mol, preferably from 0.5 to 2 mol, of the substituted phenol of the formula (III) are employed per mole of the benzyl halide of the formula (II).

For carrying out the process d) according to the invention for preparing the compounds of the formula (1), in general from 0.2 to 5 mol, preferably from 0.5 to 2 mol, of alkylating agent are employed per mole of the heterocyclylphenyl benzyl ether of the formula (I) where Het is tetrazolyl.

Suitable diluents for carrying out the process b) according to the invention are all inert organic solvents. These preferably include aliphatic, alicyclic or aromatic hydrocarbons, such as, for example, petroleum ether, hexane, heptane, cyclohexane, methylcyclohexane, benzene, toluene, xylene or decalin; halogenated hydrocarbons, such as, for example, chlorobenzene, dichlorobenzene, dichloromethane, chloroform, carbon tetrachloride, dichloroethane or trichloroethane; ethers, such as diethyl ether, diisopropyl ether, methyl t-butyl ether, methyl t-amyl ether, dioxane, tetrahydrofuran, 1,2-dimethoxyethane, 1,2-diethoxyethane or anisole; nitriles, such as acetonitrile, propionitrile, n- or i-butyronitrile or benzonitrile; amides, such as N,N-dimethylformamide, N,N-dimethylacetamide, N-methylformanilide, N-methylpyrrolidone or hexamethylphosphoric triamide; esters, such as methyl acetate or ethyl acetate; sulfoxides, such as dimethyl sulfoxide; sulfones, such as sulfolane; alcohols, such as methanol, ethanol, n- or i-propanol, n-, i-, sec- or tert-butanol, ethanediol, propane-1,2-diol, ethoxyethanol, methoxyethanol, diethylene glycol monomethyl ether, diethylene glycol monoethyl ether, mixtures thereof with water or pure water.

When carrying out the process b) according to the invention, the reaction temperatures can be varied within a relatively wide range. In general, the process is carried out at temperatures of from −20° C. to 120° C., preferably at temperatures of from 0° C. to 80° C.

For carrying out the process b) according to the invention for preparing the compounds of the formula (I), in general from 1 to 1.5 mol, preferably from 1.1 to 1.3 mol, of methylamine are employed per mole of the heterocyclylphenyl benzyl ether of the formula (1).

Suitable diluents for carrying out the process c) according to the invention are all inert polar organic solvents. These preferably include nitrites, such as acetonitrile, propionitrile, n- or i-butyronitrile or benzonitrile; amides, such as N,N-dimethylformamide, N,N-dimethylacetamide, N-methylformanilide, N-methylpyrrolidone or hexamethylphosphoric triamide; sulfoxides, such as dimethyl sulfoxide or sulfones, such as sulfolane.

When carrying out the process c) according to the invention, the reaction temperatures can be varied within a relatively wide range. In general, the process is carried out at temperatures of from 20° C. to 200° C., preferably at temperatures of from 50° C. to 150° C.

When carrying out the process c) according to the invention for preparing the compounds of the formula (I), in general from 1 to 10 mol, preferably from 1 to 5 mol, of azide are employed per mole of the compounds of the formula (IV).

Suitable diluents for carrying out the process e) according to the invention are halogenated hydrocarbons, such as, for example, chlorobenzene, dichlorobenzene, dichloromethane, chloroform, carbon tetrachloride, dichloroethane or trichloroethane.

When carrying out the process e) according to the invention, the reaction temperatures can be varied within a relatively wide range. In general, the process is carried out at temperatures of from −50° C. to 50° C., preferably at temperatures of from −20° C. to 25° C.

For carrying out the process e) according to the invention for preparing the compounds of the formula (III), in general from 0.4 to 2 mol, preferably from 0.5 to 1.5 mol, of the Lewis acid are employed per mole of the compounds of the formula (V).

A particularly preferred Lewis acid for carrying out the process e) according to the invention is boron tribromide.

Suitable diluents for carrying out the process f) according to the invention are all inert organic solvents. These preferably include aliphatic, alicyclic or aromatic hydrocarbons, such as, for example, petroleum ether, hexane, heptane, cyclohexane, methylcyclohexane, benzene, toluene, xylene or decalin; halogenated hydrocarbons, such as, for example, chlorobenzene, dichlorobenzene, dichloromethane, chloroform, carbon tetrachloride, dichloroethane or trichloroethane; ethers, such as diethyl ether, diisopropyl ether, methyl t-butyl ether, methyl t-amyl ether, dioxane, tetrahydrofuran, 1,2-dimethoxyethane, 1,2-diethoxyethane or anisole; nitriles, such as acetonitrile, propionitrile, n- or i-butyronitrile or benzonitrile; amides, such as N,N-dimethylformamide, N,N-dimethylacetamide, N-methylformanilide, N-methylpyrrolidone or hexamethylphosphoric triamide; esters, such as methyl acetate or ethyl acetate; sulfoxides, such as dimethyl sulfoxide; sulfones, such as sulfolane; alcohols, such as methanol, ethanol, n- or i-propanol, n-, i-, sec- or tert-butanol, ethanediol, propane-1,2-diol, ethoxyethanol, methoxyethanol, diethylene glycol monomethyl ether, diethylene glycol monoethyl ether, mixtures thereof with water or pure water.

When carrying out the process f) according to the invention, the reaction temperatures can be varied within a relatively wide range. In general, the process is carried out at temperatures of from 50° C. to 150° C., preferably at temperatures of from 80° C. to 120° C.

For carrying out the process f) according to the invention for preparing the compounds of the formula (V), in general from 1 to 3 mol, preferably from 1.5 to 2 mol, of alkali metal azide are employed per mole of the compounds of the formula (VI)

For carrying out the process f) according to the invention for preparing the compounds of the formula (V), 1 to 3 mol, preferably from 1.5 to 2 mol, of a reaction auxiliary are employed per mole of the compounds of the formula (V).

Suitable reaction auxiliaries for carrying out the process f) according to the invention are, in particular, ammonium salts, preferably trialkylammonium salts, particularly preferably triethylammonium chloride or ammonium chloride.

A preferred diluent for carrying out the process g) according to the invention is the orthoester of the formula (VIII).

When carrying out the process g) according to the invention, the reaction temperatures can be varied within a relatively wide range. In general, the process is carried out at temperatures of from 80° C. to 160° C., preferably at temperatures of from 90° C. to 150° C.

Suitable diluents for carrying out the process h) according to the invention are all inert organic solvents. These preferably include aliphatic, alicyclic or aromatic hydrocarbons, such as, for example, petroleum ether, hexane, heptane, cyclohexane, methylcyclohexane, benzene, toluene, xylene or decalin; halogenated hydrocarbons, such as, for example, chlorobenzene, dichlorobenzene, dichloromethane, chloroform, carbon tetrachloride, dichloroethane or trichloroethane; ethers, such as diethyl ether, diisopropyl ether, methyl t-butyl ether, methyl t-amyl ether, dioxane, tetrahydrofuran, 1,2-dimethoxyethane, 1,2-diethoxyethane or anisole; nitriles, such as acetonitrile, propionitrile, n- or i-butyronitrile or benzonitrile; amides, such as N,N-dimethylformamide, N,N-dimethylacetamide, N-methylformanilide, N-methylpyrrolidone or hexamethylphosphoric triamide; esters, such as methyl acetate or ethyl acetate; sulfoxides, such as dimethyl sulfoxide; sulfones, such as sulfolane; alcohols, such as methanol, ethanol, n- or i-propanol, n-, i-, sec- or tert-butanol, ethanediol, propane-1,2-diol, ethoxyethanol, methoxyethanol, diethylene glycol monomethyl ether, diethylene glycol monoethyl ether, mixtures thereof with water or pure water.

When carrying out the process h) according to the invention, the reaction temperatures can be varied within a relatively wide range. In general, the process is carried out at temperatures of from 0° C. to 120° C., preferably at temperatures of from 20° C. to 100° C.

For carrying out the process h) according to the invention for preparing the compounds of the formula (V), in general from 0.9 to 1.2 mol, preferably from 1.0 to 1.1 mol, of the compound of the formula (X) are employed per mole of the compounds of the formula (IX).

Palladium compounds suitable for use as catalyst in the process h) according to the invention are, for example, bis(dibenzalacetone)palladium, palladium acetate, palladium dichloride, palladium dibromide, palladium trifluoroacetate, palladiumdiphosphine halide complexes and palladiumdiphosphine acetate complexes such as palladium(triphenylphosphine) acetate. Preference is given to tetrakis(triphenylphosphine)palladium.

The process h) according to the invention is, if appropriate, carried out in the presence of a suitable acid acceptor. Suitable acid acceptors are all customary inorganic or organic bases. These preferably include alkaline earth metal or alkali metal hydrides, hydroxides, amides, alkoxides, acetates, carbonates or bicarbonates, such as, for example, sodium hydride, sodium amide, sodium methoxide, sodium ethoxide, potassium tert-butoxide, sodium hydroxide, potassium hydroxide, ammonium hydroxide, sodium carbonate, potassium carbonate, potassium bicarbonate, sodium bicarbonate or ammonium carbonate, and also tertiary amines, such as, for example, trimethylamine, triethylamine, tributylamine, N,N-dimethylaniline, N,N-dimethylbenzylamine, pyridine, N-methylpiperidine, N-methylmorpholine, N,N-dimethylaminopyridine, diazabicyclooctane (DABCO), diazabicyclononene (DBN) or diazabicycloundecene (DBU). A preferred acid acceptor for carrying out the process h) according to the invention is sodium carbonate.

Suitable diluents for carrying out the process i) according to the invention are all inert organic solvents. These preferably include aliphatic, alicyclic or aromatic hydrocarbons, such as, for example, petroleum ether, hexane, heptane, cyclohexane, methylcyclohexane, benzene, toluene, xylene or decalin; halogenated hydrocarbons, such as, for example, chlorobenzene, dichlorobenzene, dichloromethane, chloroform, carbon tetrachloride, dichloroethane or trichloroethane; ethers, such as diethyl ether, diisopropyl ether, methyl t-butyl ether, methyl t-amyl ether, dioxane, tetrahydrofuran, 1,2-dimethoxyethane, 1,2-diethoxyethane or anisole; nitriles, such as acetonitrile, propionitrile, n- or i-butyronitrile or benzonitrile; amides, such as N,N-dimethylformamide, N,N-dimethylacetamide, N-methylformanilide, N-methylpyrrolidone or hexamethylphosphoric triamide; esters, such as methyl acetate or ethyl acetate; sulfoxides, such as dimethyl sulfoxide; sulfones, such as sulfolane; alcohols, such as methanol, ethanol, n- or i-propanol, n-, i-, sec- or tert-butanol, ethanediol, propane-1,2-diol, ethoxyethanol, methoxyethanol, diethylene glycol monomethyl ether, diethylene glycol monoethyl ether, mixtures thereof with water or pure water.

When carrying out the process i) according to the invention, the reaction temperatures can be varied within a relatively wide range. In general, the process is carried out at temperatures of from 0° C. to 100° C., preferably at temperatures of from 20° C. to 80° C.

For carrying out the process i) according to the invention for preparing the compounds of the formula (V), in general from 0.9 to 1.5 mol, preferably from 1 to 1.1 mol, of alkylating agent are employed per mole of the compounds of the formula (V) where Het is tetrazolyl.

The process i) according to the invention is, if appropriate, carried out in the presence of a suitable acid acceptor. Suitable acid acceptors are all customary inorganic or organic bases. These preferably include alkaline earth metal or alkali metal hydrides, hydroxides, amides, alkoxides, carbonates or bicarbonates, such as, for example, sodium hydride, sodium amide, sodium methoxide, sodium ethoxide, potassium tert-butoxide, sodium hydroxide, potassium hydroxide, sodium carbonate, potassium carbonate, potassium bicarbonate or sodium bicarbonate, and also tertiary amines, such as trimethylamine, triethylamine, tributylamine, N,N-dimethylaniline, N,N-dimethylbenzylamine, pyridine, N-methylpiperidine, N-methylmorpholine, N,N-dimethylaminopyridine, diazabicyclooctane (DABCO), diazabicyclononene (DBN) or diazabicycloundecene (DBU).

Suitable diluents for carrying out the process j) according to the invention are alcohols, such as methanol, ethanol, n- or i-propanol, n-, i-, sec- or tert-butanol, ethanediol, propane-1,2-diol, ethoxyethanol, methoxyethanol, diethylene glycol monomethyl ether, diethylene glycol monoethyl ether, mixtures thereof with water or pure water. Preference is given to ethanol.

When carrying out the process j) according to the invention, the reaction temperatures can be varied within a relatively wide range. In general, the process is carried out at temperatures of from 0° C. to 100° C., preferably at temperatures of from 20° C. to 80° C.

For carrying out the process j) according to the invention for preparing the compounds of the formula (VII), in general from 1 to 2 mol, preferably from 1 to 1.1 mol, of hydroxylamine or acid addition complexes thereof are employed per mole of the compounds of the formula (VI).

Suitable diluents for carrying out the process k) according to the invention are all inert organic solvents. These preferably include aliphatic, alicyclic or aromatic hydrocarbons, such as, for example, petroleum ether, hexane, heptane, cyclohexane, methylcyclohexane, benzene, toluene, xylene or decalin; halogenated hydrocarbons, such as, for example, chlorobenzene, dichlorobenzene, dichloromethane, chloroform, carbon tetrachloride, dichloroethane or trichloroethane; ethers, such as diethyl ether, diisopropyl ether, methyl t-butyl ether, methyl t-amyl ether, dioxane, tetrahydrofuran, 1,2-dimethoxyethane, 1,2-diethoxyethane or anisole; nitriles, such as acetonitrile, propionitrile, n- or i-butyronitrile or benzonitrile; amides, such as N,N-dimethylformamide, N,N-dimethylacetamide, N-methylformanilide, N-methylpyrrolidone or hexamethylphosphoric triamide; esters, such as methyl acetate or ethyl acetate; sulfoxides, such as dimethyl sulfoxide; sulfones, such as sulfolane; alcohols, such as methanol, ethanol, n- or i-propanol, n-, i-, sec- or tert-butanol, ethanediol, propane-1,2-diol, ethoxyethanol, methoxyethanol, diethylene glycol monomethyl ether, diethylene glycol monoethyl ether, mixtures thereof with water or pure water.

When carrying out the process k) according to the invention, the reaction temperatures can be varied within a relatively wide range. In general, the process is carried out at temperatures of from 0° C. to 100° C., preferably at temperatures of from 20° C. to 80° C.

For carrying out the process k) according to the invention and for the preparation of the compounds of the formula (IV), in general from 1.1 to 1.3 mol, preferably from 1.0 to 1.1 mol, of compounds of the formula (II) are employed per mole of the compounds of the formula (XI).

The processes according to the invention are generally carried out under atmospheric pressure. However, it is also possible to operate under elevated or reduced pressure—in general between 0.1 bar and 10 bar.

The practice of the reaction, the work-up and the isolation of the reaction products are carried out by generally customary methods (compare also the Preparation Examples).

The examples below serve to illustrate the invention. However, the invention is not limited to the examples.

The substances according to the invention have potent microbicidal activity and can be employed for controlling unwanted microorganisms, such as fungi and bacteria, in crop protection and in the protection of materials.

Fungicides can be employed in crop protection for controlling Plasmodiophoromycetes, Oomycetes, Chytridiomycetes, Zygomycetes, Ascomycetes, Basidiomycetes and Deuteromycetes.

Bactericides can be employed in crop protection for controlling Pseudomonadaceae, Rhizobiaceae, Enterobacteriaceae, Corynebacteriaceae and Streptomycetaceae.

Some pathogens causing fungal and bacterial diseases which come under the generic names listed above may be mentioned as examples, but not by way of limitation:

Xanthomonas species, such as, for example, Xanthomonas campestris pv. oryzae;

Pseudomonas species, such as, for example, Pseudomonas syringae pv. lachrymans;

Erwinia species, such as, for example, Erwinia amylovora;

Pythium species, such as, for example, Pythium ultimum;

Phytophthora species, such as, for example, Phytophthora infestans;

Pseudoperonospora species, such as, for example, Pseudoperonospora humuli or Pseudoperonospora cubensis;

Plasmopara species, such as, for example, Plasmopara viticola;

Bremia species, such as, for example, Bremia lactucae;

Peronospora species, such as, for example, Peronospora pisi or P. brassicae;

Erysiphe species, such as, for example, Erysiphe graminis;

Sphaerotheca species, such as, for example, Sphaerotheca fuliginea;

Podosphaera species, such as, for example, Podosphaera leucotricha;

Venturia species, such as, for example, Venturia inaequalis;

Pyrenophora species, such as, for example, Pyrenophora teres or P. graminea (conidia form: Drechslera, syn: Helminthosporium);

Cochliobolus species, such as, for example, Cochliobolus sativus (conidia form: Drechslera, syn: Helminthosporium);

Uromyces species, such as, for example, Uromyces appendiculatus;

Puccinia species, such as, for example, Puccinia recondita;

Sclerotinia species, such as, for example, Sclerotinia sclerotiorum;

Tilletia species, such as, for example, Tilletia caries;

Ustilago species, such as, for example, Ustilago nuda or Ustilago avenae;

Pellicularia species, such as, for example, Pellicularia sasakii;

Pyricularia species, such as, for example, Pyricularia oryzae;

Fusarium species, such as, for example, Fusarium culmorum;

Botrytis species, such as, for example, Botrytis cinerea;

Septoria species, such as, for example, Septoria nodorum;

Leptosphaeria species, such as, for example, Leptosphaeria nodorum;

Cercospora species, such as, for example, Cercospora canescens;

Altemaria species, such as, for example, Altemaria brassicae; and

Pseudocercosporella species, such as, for example, Pseudocercosporella herpotrichoides.

The active compounds according to the invention also have very good fortifying action in plants. Accordingly, they can be used for mobilizing the plant's own defenses against attack by unwanted microorganisms.

In the present context, plant-fortifying (resistance-inducing) substances are to be understood as meaning those substances which are capable of stimulating the defense system of plants such that, when the treated plants are subsequently inoculated with unwanted microorganisms, they show substantial resistance against these microorganisms.

In the present case, unwanted microorganisms are to be understood as meaning phytopathogenic fungi, bacteria and viruses. Accordingly, the substances according to the invention can be used to protect plants for a certain period after the treatment against attack by the pathogens mentioned. The period for which protection is provided generally extends over 1 to 10 days, preferably 1 to 7 days, after the treatment of the plants with the active compounds.

The fact that the active compounds are well tolerated by plants at the concentrations required for controlling plant diseases permits treatment of above-ground parts of plants, of propagation stock and seeds, and of the soil.

The active compounds according to the invention can be used with particularly good results for controlling cereal diseases, such as, for example, against Erysiphe species, and also diseases in viticulture and the cultivation of fruits and vegetables, such as, for example, against Sphaerotheca species.

The active compounds according to the invention are also suitable for increasing the yield of crops. In addition, they show reduced toxicity and are well tolerated by plants.

At certain concentrations and application rates, the active compounds according to the invention can also be used as herbicides, for influencing plant growth and for controlling animal pests. They can also be used as intermediates and precursors for the synthesis of further active compounds.

According to the invention it is possible to treat all plants and parts of plants. By plants are understood here all plants and plant populations such as desired and undesired wild plants or crop plants (including naturally occurring crop plants). Crop plants can be plants which can be obtained by conventional breeding and optimization methods or by biotechnological and genetic engineering methods or combinations of these methods, including the transgenic plants and including the plant varieties which can or cannot be protected by varietal property rights. Parts of plants are to be understood as meaning all above-ground and below-ground parts and organs of plants, such as shoot, leaf, flower and root, examples which may be mentioned being leaves, needles, stems, trunks, flowers, fruit-bodies, fruits and seeds and also roots, tubers and rhizomes. Parts of plants also include harvested plants and vegetative and generative propagation material, for example seedlings, tubers, rhizomes, cuttings and seeds.

The treatment of the plants and parts of plants with the active compounds according to the invention is carried out directly or by action on their surroundings, habitat or storage space, according to customary treatment methods, for example by dipping, spraying, evaporating, atomizing, broadcasting, spreading-on and, in the case of propagation material, in particular in the case of seeds, furthermore by single- or multi-layer coating.

In the protection of materials, the compounds according to the invention can be employed for protecting industrial materials against infection with, and destruction by, undesired microorganisms.

Industrial materials in the present context are understood as meaning non-living materials which have been prepared for use in industry. For example, industrial materials which are intended to be protected by active compounds according to the invention from microbial change or destruction can be adhesives, sizes, paper and board, textiles, leather, wood, paints and plastic articles, cooling lubricants and other materials which can be infected with, or destroyed by, microorganisms. Parts of production plants, for example cooling-water circuits, which may be impaired by the proliferation of microorganisms may also be mentioned within the scope of the materials to be protected. Industrial materials which may be mentioned within the scope of the present invention are preferably adhesives, sizes, paper and board, leather, wood, paints, cooling lubricants and heat-transfer liquids, particularly preferably wood.

Microorganisms capable of degrading or changing the industrial materials which may be mentioned are, for example, bacteria, fungi, yeasts, algae and slime organisms. The active compounds according to the invention preferably act against fingi, in particular molds, wood-discolouring and wood-destroying fuigi (Basidiomycetes), and against slime organisms and algae.

Microorganisms of the following genera may be mentioned as examples:

Altemaria, such as Alternaria tenuis,

Aspergillus, such as Aspergillus niger,

Chaetomium, such as Chaetomium globosum,

Coniophora, such as Coniophora puetana,

Lentinus, such as Lentinus tigrinus,

Penicillium, such as Penicillium glaucum,

Polyporus, such as Polyporus versicolor,

Aureobasidium, such as Aureobasidium pullulans,

Sclerophoma, such as Sclerophoma pityophila,

Trichoderma, such as Trichoderma viride,

Escherichia, such as Escherichia coli,

Pseudomonas, such as Pseudomonas aeruginosa, and

Staphylococcus, such as Staphylococcus aureus.

Depending on their particular physical and/or chemical properties, the active compounds can be converted to the customary formulations, such as solutions, emulsions, suspensions, powders, foams, pastes, granules, aerosols and microencapsulations in polymeric substances and in coating compositions for seeds, and ULV cool and warm fogging formulations.

These formulations are produced in a known manner, for example by mixing the active compounds with extenders, that is, liquid solvents, liquefied gases under pressure, and/or solid carriers, optionally with the use of surfactants, that is emulsifiers and/or dispersants, and/or foam formers. If the extender used is water, it is also possible to employ, for example, organic solvents as auxiliary solvents. Essentially, suitable liquid solvents are: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example petroleum fractions, alcohols such as butanol or glycol and their ethers and esters, ketones such as acetone, methyl ethyl ketone, methyl isobutyl ketone or cyclohexanone, strongly polar solvents such as dimethylformamide or dimethyl sulfoxide, or else water. Liquefied gaseous extenders or carriers are to be understood as meaning liquids which are gaseous at standard temperature and under atmospheric pressure, for example aerosol propellants such as halogenated hydrocarbons, or else butane, propane, nitrogen and carbon dioxide. Suitable solid carriers are: for example ground natural minerals such as kaolins, clays, talc, chalk, quartz, attapulgite, montmorillonite or diatomaceous earth, and ground synthetic minerals such as finely divided silica, alumina and silicates. Suitable solid carriers for granules are: for example crushed and fractionated natural rocks such as calcite, marble, pumice, sepiolite and dolomite, or else synthetic granules of inorganic and organic meals, and granules of organic material such as sawdust, coconut shells, corn cobs and tobacco stalks. Suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulfonates, alkyl sulfates, arylsulfonates, or else protein hydrolysates. Suitable dispersants are: for example lignosulfite waste liquors and methylcellulose.

Tackifiers such as carboxymethylcellulose and natural and synthetic polymers in the form of powders, granules or latices, such as gum arabic, polyvinyl alcohol and polyvinyl acetate, or else natural phospholipids such as cephalins and lecithins and synthetic phospholipids can be used in the formulations. Other possible additives are mineral and vegetable oils.

It is possible to use colorants such as inorganic pigments, for example iron oxide, titanium oxide and Prussian Blue, and organic dyestuffs such as alizarin dyestuffs, azo dyestuffs and metal phthalocyanine dyestuffs, and trace nutrients such as salts of iron, manganese, boron, copper, cobalt, molybdenum and zinc.

The formulations generally comprise between 0.1 and 95 percent by weight of active compound, preferably between 0.5 and 90%.

The active compounds according to the invention can be used as such or in their formulations, also in a mixture with known fungicides, bactericides, acaricides, nematicides or insecticides, to broaden, for example, the activity spectrum or to prevent development of resistance. In many cases, synergistic effects are obtained, i.e. the activity of the mixture is greater than the activity of the individual components.

Examples of suitable mixing components are the following:

Fungicides:

aldimorph, ampropylfos, ampropylfos potassium, andoprim, anilazine, azaconazole, azoxystrobin,

benalaxyl, benodanil, benomyl; benzamacril, benzamacril-isobutyl, bialaphos, binapacryl, biphenyl, bitertanol, blasticidin-S, bromuconazole, bupirimate, buthiobate,

calcium polysulfide, capsimycin, captafol, captan, carbendazim, carboxin, carvon, quinomethionate, chlobenthiazone, chlorfenazole, chloroneb, chloropicrin, chlorothalonil, chlozolinate, clozylacon, cufraneb, cymoxanil, cyproconazole, cyprodinil, cyprofuram, carpropamid,

debacarb, dichlorophen, diclobutrazole, diclofluanid, diclomezine, dicloran, diethofencarb, difenoconazole, dimethirimol, dimethomorph, diniconazole, diniconazole-M, dinocap, diphenylamine, dipyrithione, ditalimfos, dithianon, dodemorph, dodine, drazoxolon,

edifenphos, epoxiconazole, etaconazole, ethirimol, etridiazole,

famoxadon, fenapanil, fenarimol, fenbuconazole, fenfuram, fenitropan, fenpiclonil, fenpropidin, fenpropimorph, fentin acetate, fentin hydroxide, ferbam, ferimzone, fluazinam, flumetover, fluoromide, fluquinconazole, flurprimidol, flusilazole, flusulfamide, flutolanil, flutriafol, folpet, fosetyl-aluminum, fosetyl-sodium, fthalide, fuberidazole, furalaxyl, furametpyr, furcarbonil, fiurconazole, furconazole-cis, furmecyclox, fenhexamid,

guazatine,

hexachlorobenzene, hexaconazole, hymexazole,

imazalil, imibenconazole, iminoctadine, iminoctadine albesilate, iminoctadine triacetate, iodocarb, ipconazole, iprobenfos (IBP), iprodione, irumamycin, isoprothiolane, isovaledione, iprovalicarb,

kasugainycin, kresoxim-methyl, copper preparations, such as: copper hydroxide, copper naphthenate, copper oxychloride, copper sulfate, copper oxide, oxine-copper and Bordeaux mixture,

mancopper, mancozeb, maneb, meferimzone, mepanipyrim, mepronil, metalaxyl, metconazole, methasulfocarb, methfuroxam, metiram, metomeclam, metsulfovax, mildiomycin, myclobutanil, myclozolin,

nickel dimethyldithiocarbamate, nitrothal-isopropyl, nuarimol,

ofurace, oxadixyl, oxamocarb, oxolinic acid, oxycarboxim, oxyfenthiin,

paclobutrazole, pefurazoate, penconazole, pencycuron, phosdiphen, pimaricin, piperalin, polyoxin, polyoxorim, probenazole, prochloraz, procymidone, propamocarb, propanosine-sodium, propiconazole, propineb, pyrazophos, pyrifenox, pyrimethanil, pyroquilon, pyroxyfur,

quinconazole, quintozene (PCNB), quinoxyfen,

sulfur and sulfur preparations, spiroxamines,

tebuconazole, tecloftalam, tecnazene, tetcyclacis, tetraconazole, thiabendazole, thicyofen, thifluzamide, thiophanate-methyl, thiram, tioxymid, tolclofos-methyl, tolylfluanid, triadimefon, triadimenol, triazbutil, triazoxide, trichlamide, tricyclazole, tridemorph, triflumizole, triforine, triticonazole, trifloxystrobin

uniconazole,

validamycin A, vinclozolin, viniconazole,

zarilamide, zineb, ziram and also

Dagger G,

OK-8705, OK-8801,

α-(1,1-dimethylethyl)-β-(2-phenoxyethyl)-1H-1,2,4-triazole-1-ethanol,

α-(2,4-dichlorophenyl)-β-fluoro-b-propyl-1H-1,2,4-triazole-1-ethanol,

α-(2,4-dichlorophenyl)-β-methoxy-a-methyl-1H-1,2,4-triazole-1-ethanol,

α-(5-methyl-1,3-dioxan-5-yl)-β-[[4-(trifuoromethyl)phenyl]methylene]-1H-1,2,4-triazole-1-ethanol,

(5RS,6RS)-6-hydroxy-2,2,7,7-tetramethyl-5-(1H-1,2,4-triazol-1-yl)-3-octanone,

(E)-a-(methoxyimino)-N-methyl-2-phenoxyphenylacetamide,

1-(2,4-dichlorophenyl)-2-(1H-1,2,4-triazol-1-yl)ethanone O-(phenylmethyl)oxime,

1-(2-methyl-1-naphthalenyl)-1H-pyrrole-2,5-dione,

1-(3,5-dichlorophenyl)-3-(2-propenyl)-2,5-pyrrolidinedione,

1-[(diiodomethyl)sulfonyl]-4-methylbenzene,

1-[[2-(2,4-dichlorophenyl)-1,3-dioxolan-2-yl]methyl]-1H-imidazole,

1-[[2-(4-chlorophenyl)-3-phenyloxiranyl]methyl]-1H-1,2,4-triazole,

1-[1-[2-[(2,4-dichlorophenyl)methoxy]phenyl]ethenyl]-1H-imidazole,

1-methyl-5-nonyl-2-(phenylmethyl)-3-pyrrolidinole,

2′,6′-dibromo-2-methyl-4′-trifluoromethoxy-4′-trifluoromethyl-1,3-thiazole-5-carboxanilide,

2,6-dichloro-5-(methylthio)-4-pyrimidinylthiocyanate,

2,6-dichloro-N-(4-trifluoromethylbenzyl)benzamide,

2,6-dichloro-N-[[4-(trifluoromethyl)phenyl]methyl]benzamide,

2-(2,3,3-triiodo-2-propenyl)-2H-tetrazole,

2-[(1-methylethyl)sulfonyl]-5-(trichloromethyl)-1,3,4-thiadiazole,

2-[[6-deoxy-4-O-(4-O-methyl-β-D-glycopyranosyl)-a-D-glucopyranosyl]amino]-4-methoxy-1H-pyrrolo[2,3-d]pyrimidine-5-carbonitrile,

2-aminobutane,

2-bromo-2-(bromomethyl)pentanedinitrile,

2-chloro-N-(2,3-dihydro-1,1,3-trimethyl-1H-inden-4-yl)-3-pyridinecarboxamide,

2-chloro-N-(2,6-dimethylphenyl)-N-(isothiocyanatomethyl)acetamide,

2-phenylphenol (OPP),

3,4-dichloro-1-[4-(difluoromethoxy)phenyl]-1H-pyrrole-2,5-dione,

3,5-dichloro-N-[cyano[(1-methyl-2-propynyl)oxy]methyl]benzamide,

3-(1,1-dimethylpropyl-1-oxo-1H-indene-2-carbonitrile,

3-[2-(4-chlorophenyl)-5-ethoxy-3-isoxazolidinyl]pyridine,

4-chloro-2-cyano-N,N-dimethyl-5-(4-methylphenyl)-1H-imidazole-1-sulfonamide,

4-methyltetrazolo[1,5-a]quinazolin-5(4H)one,

8-hydroxyquinoline sulfate,

9H-xanthene-2-[(phenylamino)carbonyl]-9-carboxylic hydrazide,

bis-(1-methylethyl)-3-methyl-4-[(3-methylbenzoyl)oxy]-2,5-thiophenedicarboxylate,

cis-1-(4-chlorophenyl)-2-(1H-1,2,4-triazol-1-yl)cycloheptanol,

cis-4-[3-[4-(1,1-dimethylpropyl)phenyl-2-methylpropyl]-2,6-dimethylmorpholine-hydrochloride,

ethyl [(4-chlorophenyl)azo]cyanoacetate,

potassium hydrogen carbonate,

methanetetrathiol sodium salt,

methyl 1-(2,3-dihydro-2,2-dimethyl-1H-inden-1-yl)-1H-imidazole-5-carboxylate,

methyl N-(2,6-dimethylphenyl)-N-(5-isoxazolylcarbonyl)-DL-alaninate,

methyl N-(chloroacetyl)-N-(2,6-dimethylphenyl)-DL-alaninate,

N-(2,6-dimethylphenyl)-2-methoxy-N-(tetrahydro-2-oxo-3-furanyl)acetamide,

N-(2,6-dimethylphenyl)-2-methoxy-N-(tetrahydro-2-oxo-3-thienyl)acetamide,

N-(2-chloro-4-nitrophenyl)-4-methyl-3-nitrobenzenesulfonamide,

N-(4-cyclohexylphenyl)-1,4,5,6-tetrahydro-2-pyrimidineamine,

N-(4-hexylphenyl)-1,4,5,6-tetrahydro-2-pyrimidineamine,

N-(5-chloro-2-methylphenyl)-2-methoxy-N-(2-oxo-3-oxazolidinyl)acetamide,

N-(6-methoxy-3-pyridinyl)cyclopropanecarboxamide,

N-[2,2,2-trichloro-1-[(chloroacetyl)amino]ethyl]benzamide,

N-[3-chloro-4,5-bis-(2-propinyloxy)phenyl]-N′-methoxymethanimidamide,

N-formyl-N-hydroxy-DL-alanine sodium salt,

O,O-diethyl [2-(dipropylamino)-2-oxoethyl]ethylphosphoramidothioate,

O-methyl S-phenyl phenylpropylphosphoramidothioate,

S-methyl 1,2,3-benzothiadiazole-7-carbothioate,

spiro[2H]-1-benzopyrane-2,1′(3′H)-isobenzofuran]-3′-one,

Bactericides:

bronopol, dichlorophen, nitrapyrin, nickel dimethyldithiocarbamate, kasugamycin, octhihnone, furancarboxylic acid, oxytetracyclin, probenazole, streptomycin, tecloftalam, copper sulfate and other copper preparations.

Insecticides/Acaricides/Nematicides:

abamectin, acephate, acetamiprid, acrinathrin, alanycarb, aldicarb, aldoxycarb, alpha-cypermethrin, alphamethrin, amitraz, avermectin, AZ 60541, azadirachtin, azarnethiphos, azinphos A, azinphos M, azocyclotin,

Bacillus popilliae, Bacillus sphaericus, Bacillus subtilis, Bacillus thuringiensis, baculoviruses, Beauveria bassiana, Beauveria tenella, bendiocarb, benfuracarb, bensultap, benzoximate, betacyfluthrin, bifenazate, bifenthrin, bioethanomethrin, biopermethrin, BPMC, bromophos A, bufencarb, buprofezin, butathiofos, butocarboxim, butylpyridaben,

cadusafos, carbaryl, carbofuran, carbophenothion, carbosulfan, cartap, chloethocarb, chlorethoxyfos, chlorfenapyr, chlorfenvinphos, chlorfluazuron, chlormephos, chlorpyrifos, chlorpyrifos M, chlovaporthrin, cisresmethrin, cispermethrin, clocythrin, cloethocarb, clofentezine, cyanophos, cycloprene, cycloprothrin, cyfluthrin, cyhalothrin, cyhexatin, cypermethrin, cyromazine,

deltamethrin, demeton M, demeton S, demeton-S-methyl, diafenthiuron, diazinon, dichlorvos, diflubenzuron, dimethoat, dimethylvinphos, diofenolan, disulfoton, docusat-sodium, dofenapyn, eflusilanate, ernamectin, empenthrin, endosulfan, Entomopfthora spp., esfenvalerate, ethiofencarb, ethion, ethoprophos, etofenprox, etoxazole, etrimfos,

fenarniphos, fenazaquin, fenbutatin oxide, fenitrothion, fenothiocarb, fenoxacrim, fenoxycarb, fenpropathrin, fenpyrad, fenpyrithrin, fenpyroximate, fenvalerate, fipronil, fluazuron, flubrocythrinate, flucycloxuron, flucythrinate, flufenoxuron, flutenzine, fluvalinate, fonophos, fosmethilan, fosthiazate, fubfenprox, furathiocarb,

granulosis viruses,

halofenozide, HCH, heptenophos, hexaflumuron, hexythiazox, hydroprene,

imidacloprid, isazofos, isofenphos, isoxathion, ivermectin,

nuclear polyhedrosis viruses,

lambda-cyhalothrin, lufenuron,

malathion, mecarbam, metaldehyde, methamidophos, Metharhizium anisopliae, Metharhizium flavoviride, methidathion, methiocarb, methomyl, methoxyfenozide, metolcarb, metoxadiazone, mevinphos, milbemectin, monocrotophos,

naled, nitenpyram, nithiazine, novaluron,

omethoate, oxamyl, oxydemethon M,

Paecilomyces fumosoroseus, parathion A, parathion M, permethrin, phenthoate, phorat, phosalone, phosmet, phosphamidon, phoxim, pirimicarb, pirimiphos A, pirimiphos M, profenofos, promecarb, propoxur, prothiofos, prothoat, pymetrozine, pyraclofos, pyresmethrin, pyrethrum, pyridaben, pyridathion, pyrimidifen, pyriproxyfen,

quinalphos,

ribavirin,

salithion, sebufos, silafluofen, spinosad, sulfotep, sulprofos,

tau-fluvalinate, tebufenozide, tebufenpyrad, tebupirimiphos, teflubenzuron, tefluthrin, temephos, temivinphos, terbufos, tetrachlorvinphos, thetacypermethrin, thiamethoxam, thiapronil, thiatriphos, thiocyclam hydrogen oxalate, thiodicarb, thiofanox, thuringiensin, tralocythrin, tralomethrin, triarathene, triazamate, triazophos, triazuron, trichlophenidine, trichlorfon, triflumuron, trimethacarb,

vamidothion, vaniliprole, Verticillium lecanii

YI 5302

zeta-cypermethrin, zolaprofos

(1R-cis)-[5-(phenylmethyl)-3-furanyl]methyl-3-[(dihydro-2-oxo-3(2H)-furanylidene)methyl]-2,2-dimethylcyclopropanecarboxylate,

(3-phenoxyphenyl)methyl-2,2,3,3-tetramethylcyclopropanecarboxylate,

1-[(2-chloro-5-thiazolyl)methyl]tetrahydro-3,5-dimethyl-N-nitro-1,3,5-triazine-2(1H)imine,

2-(2-chloro-6-fluorophenyl)-4-[4-(1,1-dimethylethyl)phenyl]-4,5-dihydrooxazole,

2-(acetyloxy)-3-dodecyl-1,4-naphthalenedione,

2-chloro-N-[[[4-(1-phenylethoxy)phenyl]amino]carbonyl]benzamide,

2-chloro-N-[[[4-(2,2-dichloro-1,1-difluoroethoxy)phenyl]amino]carbonyl]-benzamide,

3-methylphenyl propylcarbamate,

4-[4-(4-ethoxyphenyl)-4-methylpentyl]-1-fluoro-2-phenoxybenzene,

4-chloro-2-(1,1-dimethylethyl)-5-[[2-(2,6-dimethyl-4-phenoxyphenoxy)ethyl]thio]-3(2H)-pyridazinone,

4-chloro-2-(2-chloro-2-methylpropyl)-5-[(6-iodo-3-pyridinyl)methoxy]-3(2H)-pyridazinone,

4-chloro-5-[(6-chloro-3-pyridinyl)methoxy]-2-(3,4-dichlorophenyl)-3 (2H)-pyridazinone,

Bacillus thuringiensis strain EG-2348,

[2-benzoyl-1-(1,1-dimethylethyl)hydrazinobenzoic acid,

2,2-dimethyl-3-(2,4-dichlorophenyl)-2-oxo-1-oxaspiro[4.5]dec-3-en-4-yl butanoate,

[3-[(6-chloro-3-pyridinyl)methyl]-2-thiazolidinylidene] cyanamide,

dihydro-2-(nitromethylene)-2H-1,3-thiazine-3(4H)carboxaldehyde,

ethyl [2-[[1,6-dihydro-6-oxo-1-(phenylmethyl)-4-pyridazinyl]oxy]ethyl]carbamate,

N-(3,4,4-trifluoro-1-oxo-3-butenyl)glycine,

N-(4-chlorophenyl)-3-[4-(difluoromethoxy)phenyl]-4,5-dihydro-4-phenyl-1H-pyrazole-1-carboxamide,

N-[(2-chloro-5-thiazolyl)methyl]-N′-methyl-N″-nitroguanidine,

N-methyl-N′-(1-methyl-2-propenyl)-1,2-hydrazinedicarbothioamide,

N-methyl-N′-2-propenyl-1,2-hydrazinedicarbothioamide,

O,O-diethyl [2-(dipropylamino)-2-oxoethyl]ethylphosphoramidothioate

A mixture with other known active compounds, such as herbicides, or with fertilizers and growth regulators, is also possible.

In addition, the compounds of the formula (I) according to the invention also have very good antimycotic activity. They have a very broad antimycotic activity spectrum in particular against dermatophytes and yeasts, molds and diphasic fungi (for example against Candida species, such as Candida albicans, Candida glabrata), and Epidermophyton floccosum, Aspergillus species, such as Aspergillus niger and Aspergillus fumigatus, Trichophyton species, such as Trichophyton mentagrophytes, Microsporon species such as Microsporon canis and audouinii. The list of these fungi by no means limits the mycotic spectrum covered, but is only for illustration.

The active compounds can be used as such, in the form of their formulations or the use forms prepared therefrom, such as ready-to-use solutions, suspensions, wettable powders, pastes, soluble powders, dusts and granules. Application is carried out in a customary manner, for example by watering, spraying, atomizing, broadcasting, dusting, foaming, spreading, etc. It is furthermore possible to apply the active compounds by the ultra-low volume method, or to inject the active compound preparation or the active compound itself into the soil. It is also possible to treat the seeds of the plants.

When using the active compounds according to the invention as fungicides, the application rates can be varied within a relatively wide range, depending on the kind of application. For the treatment of parts of plants, the active compound application rates are generally between 0.1 and 10,000 g/ha, preferably between 10 and 1000 g/ha. For seed dressing, the active compound application rates are generally between 0.001 and 50 g per kilogram of seed, preferably between 0.01 and 10 g per kilogram of seed. For the treatment of the soil, the active compound application rates are generally between 0.1 and 10,000 g/ha, preferably between 1 and 5000 g/ha.

For Insecticides and Fungicides:

As already mentioned above, it is possible to treat all plants and their parts with active compounds according to the invention. In a preferred embodiment, wild plant species and plant cultivars, or those obtained by conventional biological breeding, such as crossing or protoplast fusion, and parts thereof, are treated. In a further preferred embodiment, transgenic plants and plant cultivars obtained by genetic engineering, if appropriate in combination with conventional methods (Genetic Modified Organisms), and parts thereof are treated. The term “parts” or “parts of plants” or “plant parts” has been explained above.

Particularly preferably, plants of the plant cultivars which are in each case commercially available or in use are treated according to the invention. Plant cultivars are to be understood as meaning plants with new properties (“traits”), which have been bred using conventional breeding methods, mutagenesis or recombinant DNA techniques. These can be cultivars, races, biotypes and genotypes.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the substances and compositions which can be used according to the invention, better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products are possible which exceed the effects which were actually to be expected.

The transgenic plants or plant cultivars (i.e. those obtained by genetic engineering) which are preferably treated according to the invention include all plants which, in the genetic modification, contain genetic material which imparts particularly advantageous useful properties (“traits”) to these plants. Examples of such properties are better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products. Further and particularly emphasized examples of such properties are a better defense of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), corn, soybeans, potatoes, cotton, oilseed rape and also fruit plants (with the fruits apples, pears, citrus fruits and grapes), and particular emphasis is given to corn, soybeans, potatoes, cotton and oilseed rape. Traits that are emphasized are in particular increased defense of the plants against insects by toxins formed in the plants, in particular those formed in the plants by the genetic material from Bacillus thuringiensis (for example by the genes CryIA(a), CryIA(b), CryIA(c), CryIIA, CryIA, CryIIIB2, Cry9c Cry2Ab, Cry3Bb and CryIF and also combinations thereof) (hereinbelow referred to as “Bt plants”).

Traits that are likewise particularly emphasized are the increased resistance of plants against fungi, bacteria and viruses by systemic acquired resistance (SAR), systemin, phytoalexins, elicitors and resistance genes and the corresponding expressed proteins and toxins. Traits that are furthermore particularly emphasized are the increased tolerance of the plants to certain herbicidally active compounds, for example imidazolinones, sulfonylureas, glyphosate or phosphinotricin (for example the “PAT” gene). The genes which impart the desired traits in question can also be present in combinations with one another in the transgenic plants. Examples of “Bt plants” which may be mentioned are corn varieties, cotton varieties, soybean varieties and potato varieties which are sold under the trade names YIELD GARD® (for example corn, cotton, soybeans), KnockOut® (for example corn), StarLink® (for example corn), Bollgard® (cotton), Nucoton® (cotton) and NewLeaf® (potato). Examples of herbicide-tolerant plants which may be mentioned are corn varieties, cotton varieties and soybean varieties which are sold under the trade names Roundup Ready® (tolerance to glyphosate, for example corn, cotton, soybean), Liberty Link® (tolerance to phosphinotricin, for example oilseed rape), IMI® (tolerance to imidazolinones) and STS® (tolerance to sulfonylureas, for example corn). Herbicide-resistant plants (plants bred in a conventional manner for herbicide tolerance) which may be mentioned include the varieties sold under the name Clearfield® (for example corn). Of course, these statements also apply to plant cultivars having these genetic traits or genetic traits still to be developed, which plant cultivars will be developed and/or marketed in the future.

The plants listed can be treated according to the invention in a particularly advantageous manner with the compounds of the formula (I) or the active compound mixtures according to the invention. The preferred ranges stated above for the active compounds and mixtures also apply to the treatment of these plants. Particular emphasis is given to the treatment of plants with the compounds or mixtures specifically mentioned in the present text.

### PREPARATION EXAMPLES

### Example 1

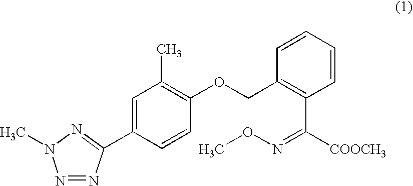

Process a)

A mixture of 2 g (0.0105 mol) of 5-(3-methyl-4-hydroxyphenyl)tetrazole, 1.7 g (0.0126 mol) of potassium carbonate, 4.1 g (0.014 mol) of methyl 2-bromomethylphenylglyoxylate O-methyl oxime (preparation see, for example, EP 420091) and 80 ml of acetonitrile is heated under reflux for 18 hours. The reaction mixture is then filtered off with suction through Celite and the filtercake is washed with acetonitrile. The filtrate is concentrated under reduced pressure and the residue is triturated with diisopropyl ether and filtered off with suction. This gives 4.1 g (99% of theory) of methyl 2-[4-(2-methyltetrazol-5-yl)-2-methylphenoxy]methylphenylglyoxylate O-methyl oxime in the form of a colorless powder of log P (pH 2)=3.08 (content according to HPLC: 98%).

### Example 2

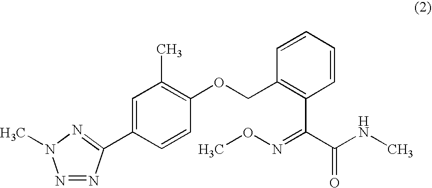

Process b)

3.2 g (0.0081 mol) of methyl (2E)-2-(methoxyimino)-2-(2-{[2-methyl-4-(2-methyl-2H-tetrazol-5-yl)phenoxy]methyl}phenyl)acetate are dissolved in 60 ml of methanol, and 7 ml of a 40% strength solution of methylamine in water are added. The mixture is allowed to stand at room temperature overnight and the solvent is then distilled off under reduced pressure. This gives 3.1 g (97% of theory) of N-methyl-2-[4-(2-methyltetrazol-5-yl)-2-methylphenoxy]methylphenylglyoxylamide O-methyl oxime as a colorless powder of log P (pH 2)=2.58 (content according to HPLC: 95%).

### Example 3

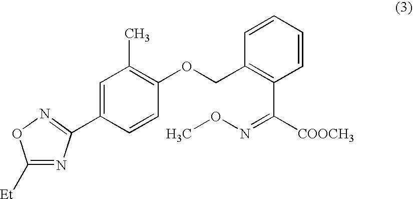

Process a)

A mixture of 0.8 g (3.9 mmol) of 5-ethyl-3-(3-methyl-4-hydroxyphenyl)-1,2,4-oxadiazole, 0.65 g (4.7 mmol) of potassium carbonate, 1.4 g (3.9 mmol) of methyl 2-bromomethylphenylglyoxylate O-methyl oxime (preparation see, for example, EP 420091) and 30 ml of acetonitrile is heated under reflux for 18 hours. The reaction mixture is then filtered off with suction through Celite and the filtercake is washed with acetonitrile. The filtrate is concentrated under reduced pressure and the residue is triturated with diisopropyl ether and filtered off with suction. This gives 1.1 g (68% of theory) of methyl 2-[4-(5-ethyl-1,2,4-oxadiazol-3-yl)-2-methylphenoxy]methylphenylglyoxylate O-methyl oxime in the form of a colorless powder of log P (pH2)=3.80 (content according to HPLC: 96.5%).

### Example 4

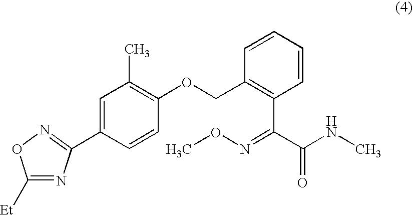

Process b)

0.6 g (1.47 mmol) of methyl 2-[4-(5-ethyl-1,2,4-oxadiazol-3-yl)-2-methylphenoxy]methylphenylglyoxylate O-methyl oxime is dissolved in 50 ml of methanol, and 1.5 ml of a 40% strength solution of methylamine in water are added. The mixture is allowed to stand at room temperature overnight and the solvent is then distilled off under reduced pressure. The residue is triturated with a mixture of petroleum ether and diisopropyl ether and the product is filtered off with suction. This gives 0.55 g (92% of theory) of N-methyl-2-[4-(5-ethyl-1,2,4-oxadiazol-3-yl)-2-methylphenoxy]methylphenylglyoxylamide O-methyl oxime as a colorless powder of log P (pH2)=3.24 (content according to HPLC: 96%).

### Example 5

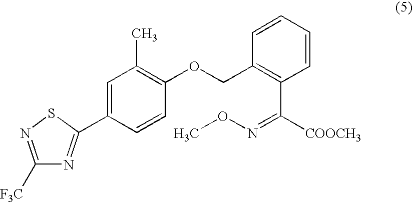

Process a)

A mixture of 0.6 g (2.3 mmol) 3-trifuoromethyl-5-(3-methyl-4-hydroxyphenyl)-1,2,4-thiadiazole, 0.5 g (3.5 mmol) of potassium carbonate, 0.8 g (2.3 mmol) of methyl 2-bromomethylphenylglyoxylate O-methyl oxime (preparation see, for example, EP 420091) and 50 ml of acetonitrile is stirred at 50° C. for 18 hours. The reaction mixture is then filtered off with suction through Celite and the filtercake is washed with acetonitrile. The filtrate is concentrated under reduced pressure and the residue is triturated with a mixture of petroleum ether and diisopropyl ether and filtered off with suction. This gives 0.8 g (74% of theory) of methyl 2-[4-(3-trifluoromethyl-1,2,4-thiadiazol-5-yl)-2-methylphenoxy]methylphenylglyoxylate O-methyl oxime in the form of a colorless powder of log P (pH2)=4.62 (content according to HPLC: 96.5%).

### Example 6

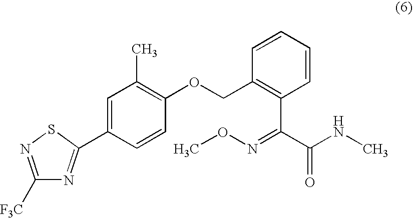

Process b)

0.5 g (1.07 mmol) of methyl 2-[4-(3-trifluoromethyl-1,2,4-thiadiazol-5-yl)-2-methylphenoxy]methylphenylglyoxylate O-methyl oxime is dissolved in 50 ml of methanol, and 1 ml of a 40% strength solution of methylamine in water is added. The mixture is allowed to stand at room temperature overnight and the solvent is then distilled off under reduced pressure. About 50 ml of water are added to the residue, and the mixture is extracted twice with in each case 30 ml of ethyl acetate. The organic phases are dried over magnesium sulfate and concentrated under reduced pressure. This gives 0.5 g (99% of theory) of N-methyl-2-[4-(3-trifluoromethyl-1,2,4-thiadiazol-5-yl)-2-methylphenoxy]methylphenylglyoxylamide O-methyl oxime as a colorless powder of logP (pH2)=4.08 (content according to HPLC: 95%).

The compounds of the formula (1) listed in Table 1 below are obtained analogously to Examples 1 to 6 and in accordance with the statements in the general descriptions of the processes.

TABLE 1

| | |
|---|---|
| | (I) |
| 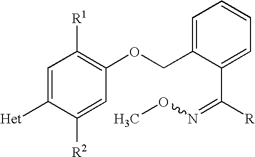 | |

| Ex. | | | | | |
|---|---|---|---|---|---|
| No. | R⁴ | R¹ | R² | R³ | logP |
| 7 | 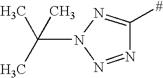 | —CH₃ | —H | —COOCH₃ | 4.21 |
| 8 | 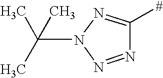 | —CH₃ | —H | —CO—NH—CH₃ | 3.65 |
| 9 | 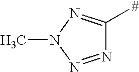 | —CH₃ | —H | 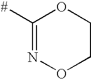 | 2.86 |
| 10 | 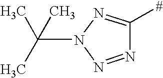 | —CH₃ | —H | 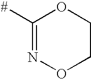 | 3.94 |
| 11 | 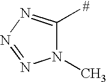 | —CH₃ | —H | —COOCH₃ | 2.6 |
| 12 | 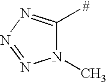 | —CH₃ | —H | —CO—NH—CH₃ | 2.15 |
| 13 | 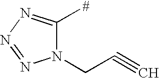 | —CH₃ | —H | —COOCH₃ | 2.85 |
| 14 | 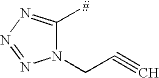 | —CH₃ | —H | —CO—NH—CH₃ | 2.15 |
| 15 | 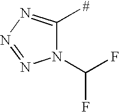 | —CH₃ | —H | —COOCH₃ | 3.22 |
| 16 | 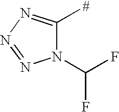 | —CH₃ | —H | —CO—NH—CH₃ | 2.75 |
| 17 | 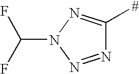 | —CH₃ | —H | —COOCH₃ | 3.72 |
| 18 | 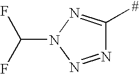 | —CH₃ | —H | —CO—NH—CH₃ | 3.2 |

# denotes the point of attachment on the phenyl ring
*) The logP values were determined in accordance with EEC Directive 79/831 Annexe V. A8 by HPLC (gradient method, acetonitrile/0.1% aqueous phosphoric acid)

Preparation of Intermediates of the Formula (V)

### Example V-1

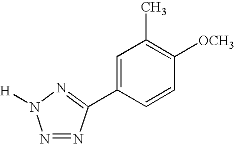

Process f)

A mixture of 26.6 g (0.18 mol) of 3-methyl-4-methoxybenzonitrile (preparation see, for example, U.S. Pat. No. 5,464,848), 49.6 g (0.36 mol) of triethylammonium chloride, 23.4 g (0.36 mol) of sodium azide and 80 ml of dimethylformamide is heated under reflux for 18 hours. The solvent is then distilled off under reduced pressure, 150 ml of a solution of sodium hydroxide in water (5% strength) are added to the residue and the mixture is extracted with petroleum ether. The aqueous phase is filtered through activated carbon and then adjusted to pH 3 using concentrated aqueous hydrochloric acid. The precipitated product is filtered off with suction and washed with water. This gives 33.8 g (99% of theory) of 5-(3-methyl-4-methoxyphenyl)tetrazole of a purity of about 98% (HPLC) and with a logp (pH2) of 1.51.

### Example V-2

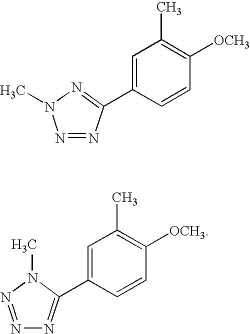

Process i)

A mixture of 11 g (0.0578 mol) of 5-(3-methyl-4-methoxyphenyl)tetrazole, 11.3 g (0.082 mol) of potassium carbonate, 11.6 g (0.082 mol) of iodomethane and 120 ml of acetonitrile is stirred at 60° C. for 18 hours. 250 ml of water are then added, and the mixture is extracted 3 times with ethyl acetate. The organic phases are washed with water, dried over sodium sulfate and concentrated under reduced pressure. This gives 10.9 g of a product which, according to HPLC analysis, consists to about 67% of the desired 2-methyl-5-(3-methyl-4-methoxyphenyl)tetrazole (logP (pH2) 2.38) and to about 32% of the isomeric 1-methyl-5-(3-methyl-4-methoxyphenyl)tetrazole.

The following compounds are also obtained according to process i):

### Example V-3

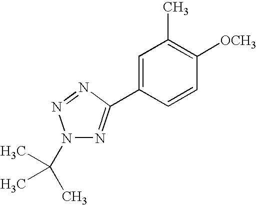

logP (pH2) 3.78

### Example V-44

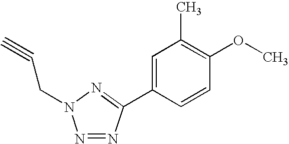

logP (pH2) 2.75

### Example V-5

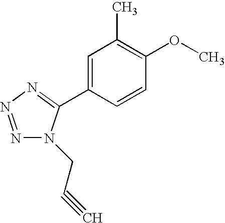

logP (pH2) 2.12

### Example V-6

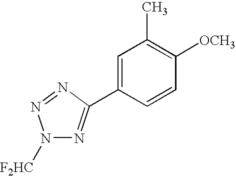

logP (pH2) 3.24

### Example V-7

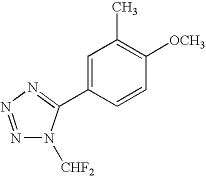

logP (pH2) 2.51

### Example V-8

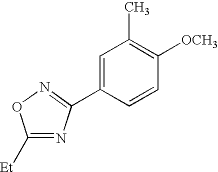

Process g)

A mixture of 3 g (0.017 mol) of 3-methyl-4-methoxybenzamideoxime and 15 ml of triethyl orthopropionate is heated under reflux for 18 hours. The volatile components are then distilled off under reduced pressure, the residue is dissolved in ethyl acetate and the solution is shaken with 5% strength aqueous sodium hydroxide solution and water. The organic phase is dried and concentrated under reduced pressure. This gives 1.6 g of a yellow oil which, according to HPLC, consists to 73% of the desired product (logP (pH2) 3.19).

### Example V-9

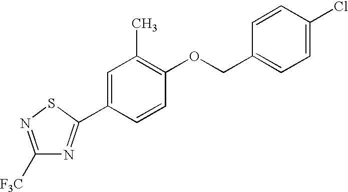

Process h)

At room temperature, 1.24 g (4.5 mmol) of 3-methyl-4-(4-chlorobenzyloxy)phenylboronic acid and 50 mg of tetrakis(triphenylphosphine)palladium(0) are added to a solution of 0.57 g (3 mmol) of 3-trifluoromethyl-5-chloro-1,2,4-thiadiazole (preparation see, for example, DE 3 228 147) in 20 ml of 1,2-dimethoxyethane. 4.8 ml of a 2M solution of sodium carbonate in water are then added, and the mixture is heated at 80° C. for 4 hours and then stirred at room temperature overnight. About 100 ml of water are added, and the reaction mixture is then extracted twice with in each case 50 ml of ethyl acetate. The organic phases are dried over sodium sulfate and concentrated under reduced pressure. What remains are 1.5 g of a product which, according to HPLC analysis, consists to about 67% of 3-trifluoromethyl-5-[3-methyl-4-(4-chlorobenzyloxy)phenyl]-1,2,4-thiadiazole (logP (pH2)=5.78).

Preparation of Intermediates of the Formula (III)

### Example III-1

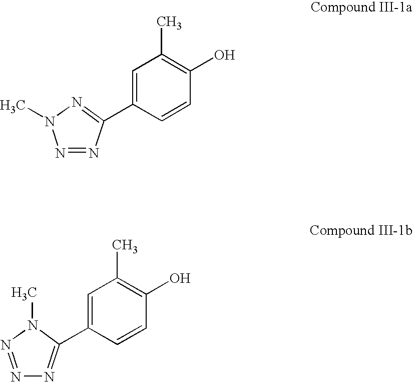

Process e)

At room temperature, 15.8 g (0.0629 mol) of boron tribromide are added dropwise to a solution of 10.7 g (0.0524 mol) of the mixture, obtained under b), of 1- and 2-methyl-5-(3-methyl-4-methoxyphenyl)tetrazole in 150 ml of anhydrous methylene chloride. After the end of the exothermic reaction, the mixture is stirred at room temperature for 3 hours, and another 7.9 g (0.0315 mol) of boron tribromide are added. The mixture is stirred at room temperature for 18 hours, the solvent is then distilled off under reduced pressure and 300 ml of a saturated solution of sodium bicarbonate in water are added to the residue. After addition of 100 ml of water, the precipitated solid is filtered off with suction and washed with water. The desired product is separated off by silica gel chromatography (methylene chloride/ethyl acetate 5:1). This gives 5.3 g (53%) of 2-methyl-5-(3-methyl-4-hydroxyphenyl)tetrazole in the form of a colorless powder of logP (pH2)=1.45 (content according to HPLC: 99%).

Also obtained are 2.5 g (25%) of isomeric 1-methyl-5-(3-methyl-4-hydroxyphenyl)tetrazole in the form of a colorless powder of logP (pH2)=1.04 (content according to HPLC: 97%).

### Example III-2

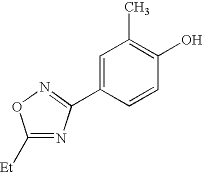

Process e)

At room temperature, 0.6 ml (6.1 mmol) of boron tribromide is added dropwise to a solution of 0.9 g. (4.1 mmol) of 5-ethyl-3-(3-methyl-4-methoxyphenyl)-1,2,4-oxadiazoline in 40 ml of anhydrous methylene chloride. The mixture is stirred at room temperature for 3 hours, and another 0.7 ml (7.1 mmol) of boron tribromide is then added. The mixture is stirred at room temperature for 18 hours, the solvent is then distilled off under reduced pressure and 30 ml of a saturated solution of sodium bicarbonate in water are added to the residue. After addition of 10 ml of water, the precipitated solid is filtered off with suction and washed with water. This gives 0.85 g of 5-ethyl-3-(3-methyl-4-hydroxyphenyl)-1,2,4-oxadiazole as a colorless powder of logP (pH2) 2.08 (content according to HPLC 96%).

### Example III-3

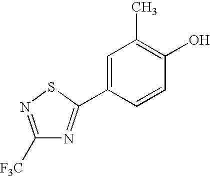

Process e)

At room temperature, 0.55 ml (5.5 mmol) of boron tribromide is added dropwise to a solution of 1.4 g (3.6 mmol) of the crude product, obtained under a), in 50 ml of anhydrous methylene chloride. The mixture is stirred at room temperature for 18 hours, the solvent is then distilled off under reduced pressure and 30 ml of a saturated solution of sodium bicarbonate in water are added to the residue. After addition of 10 ml of water, the precipitated solid is filtered off with suction and washed with water. The product is triturated with petroleum ether and filtered off with suction. This gives 0.6 g of 3-trifluoromethyl-5-(3-methyl-4-hydroxyphenyl)-1,2,4-thiadiazole as a colorless powder of logP (pH2)=3.10 (content according to HPLC 78%).

The following compounds are also obtained according to process e):

### Example III-4

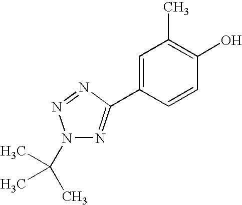

logP (pH2) 2.54

### Example III-5

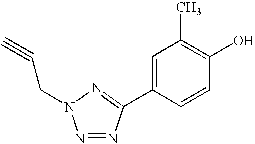

logP (pH2) 1.81

### Example III-6

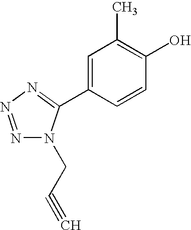

logP (pH2) 1.41

### Example III-7

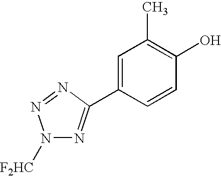

logP (pH2) 2.18

### Example III-8

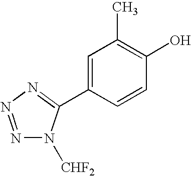

logP (pH2) 1.75

Preparation of Intermediates of the Formula (VII)

### Example VII-I

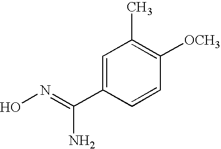

Process j)

A mixture of 9.5 g (0.065 mol) of 3-methyl-4-methoxybenzonitrile (preparation see, for example, U.S. Pat. No. 5,464,848), 9 g (0.13 mol) of hydroxylamine hydrochloride, 17.9 g (0.13 mol) of potassium carbonate and 80 ml of ethanol is heated under reflux for 18 hours. The solvent is then distilled off under reduced pressure, and the residue is triturated with 50 ml of water, filtered off with suction and washed with water. The product is triturated with ethyl acetate, filtered off with suction and washed with ethyl acetate. This gives 6.4 g of 3-methyl-4-methoxybenzamideoxime (55%) as an almost colorless powder of logP (pH2)=0.36 (content according to HPLC 95%).

### USE EXAMPLES

### Example A

Erysiphe Test (Wheat)/Protective

| | |
|---|---|
| Solvent: | 25 parts by weight of N,N-dimethylacetamide |
| Emulsifier: | 0.6 part by weight of alkylaryl polyglycol ether |

To produce a suitable preparation of active compound, 1 part by weight of active compound is mixed with the stated amounts of solvent and emulsifier, and the concentrate is diluted with water to the desired concentration.

To test for protective activity, young plants are sprayed with the preparation of active compound at the stated application rate.

After the spray coating has dried on, the plants are dusted with spores of Erysiphe graminis f.sp. tritici.

The plants are placed in a greenhouse at a temperature of about 20° C. and a relative atmospheric humidity of about 80% to promote the development of mildew pustules.

Evaluation is carried out 7 days after the inoculation. 0% means an efficacy which corresponds to that of the control, whereas an efficacy of 100% means that no infection is observed.

In this test, the compounds according to the invention listed in Examples (11, 2) show, at an application rate of 250 g/ha, an efficacy of 98% or more.

### Example B

Sphaerotheca Test (Cucumber)/Protective

| | |
|---|---|
| Solvents: | 24.5 parts by weight of acetone |
| | 24.5 parts by weight of dimethylacetamide |
| Emulsifier: | 1 part by weight of alkylaryl polyglycol ether |

To produce a suitable preparation of active compound, 1 part by weight of active compound is mixed with the stated amounts of solvent and emulsifier, and the concentrate is diluted with water to the desired concentration.

To test for protective activity, young plants are sprayed with the preparation of active compound at the stated application rate. After the spray coating has dried on, the plants are inoculated with an aqueous spore suspension of Sphaerotheca fuliginea. The plants are then placed in a greenhouse at about 23° C. and a relative atmospheric humidity of about 70%.

Evaluation is carried out 7 days after the inoculation. 0% means an efficacy which corresponds to that of the control, whereas an efficacy of 100% means that no infection is observed.

In this test, the compounds according to the invention listed in Examples (8, 9, 10) show, at an application rate of 100 g/ha, an efficacy of 97% or more.

1. A compound of the general formula (1) 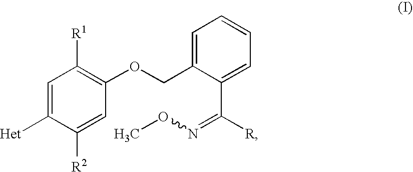
in which
R represents methoxycarbonyl, methylaminocarbonyl or represents 5,6-dihydro-1,4,2-dioxazin-3-yl,
R¹ represents alkyl,
R² represents hydrogen or alkyl and
Het represents optionally substituted tetrazolyl, 1,2,4-oxadiazolyl, 1,3,4-oxadiazolyl, 1,3,4-thiadiazolyl, 1,3-oxazolyl, 1,3-thiazolyl, pyridyl or pyrimidyl.

2. A compound of the formula (1) as claimed in claim 1, characterized in that
R represents methoxycarbonyl, methylaminocarbonyl or represents 5,6-dihydro-1,4,2-dioxazin-3-yl,
R¹ represents alkyl having 1 to 4 carbon atoms,
R² represents hydrogen or alkyl having 1 to 4 carbon atoms,
Het represents optionally substituted tetrazolyl, which is optionally substituted by alkyl having 1 to 4 carbon atoms, haloalkyl having 1 to 4 carbon atoms and 1 to 9 halogen atoms, alkenyl or alkynyl having in each case 2 to 4 carbon atoms or
represents 1,2,4-oxadiazolyl, 1,3,4-oxadiazolyl, 1,3,4-thiadiazolyl, 1,3-oxazolyl or 1,3-thiazolyl, optionally substituted by alkyl or alkoxy having in each case 1 to 4 carbon atoms, haloalkyl having 1 to 4 carbon atoms and 1 to 9 halogen atoms, alkenyl or alkynyl having in each case 2 to 4 carbon atoms or
represents pyridyl or pyrimidyl, optionally substituted by halogen, alkyl or alkoxy having in each case 1 to 4 carbon atoms, haloalkyl having 1 to 4 carbon atoms and 1 to 9 halogen atoms, alkenyl or alkynyl having in each case 2 to 4 carbon atoms.

3. A compound of the formula (I) as claimed in claim 1, characterized in that
R represents methoxycarbonyl, methylaminocarbonyl or represents 5,6-dihydro-1,4,2-dioxazin-3-yl,
R¹ represents methyl,
R² represents hydrogen or methyl,
Het represents tetrazolyl which is optionally substituted by methyl, ethyl, n- or i-propyl, n-, i-, s- or t-butyl, difluoromethyl, trifluoromethyl, allyl or propargyl or
represents 1,2,4-oxadiazolyl, 1,3,4-oxadiazolyl, 1,3,4-thiadiazolyl, 1,3-oxazolyl or 1,3-thiazolyl, optionally substituted by methyl, ethyl, n- or i-propyl, n-, i-, s- or t-butyl, methoxy, ethoxy, difluoromethyl, trifluoromethyl, allyl or propargyl or
represents pyridyl or pyrimidyl, optionally substituted by fluorine, chlorine, bromine, methyl, ethyl, n- or i-propyl, n-, i-, s- or t-butyl, methoxy, ethoxy, difluoromethyl, trifluoromethyl, allyl or propargyl.

4. A compound of the general formula (III) 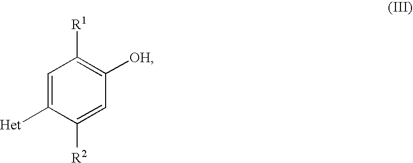
in which
R¹, R² and Het are as defined in claim 1.

5. A compound of the general formula (IV) 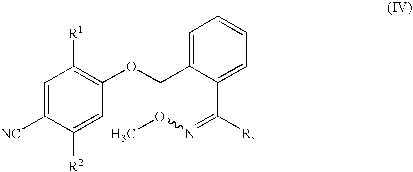
in which
R, R¹ and R² are as defined in claim 1.

6. A compound of the general formula (V) 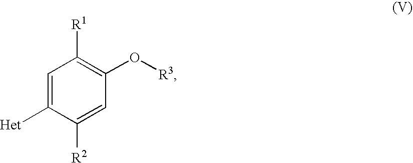
in which
R¹, R² and Het are as defined in claim 1 and
R³ represents alkyl or optionally substituted benzyl.

7. A process for preparing compounds of the general formula (1) as defined in claim 1, characterized in that
a) compounds of the formula (II) 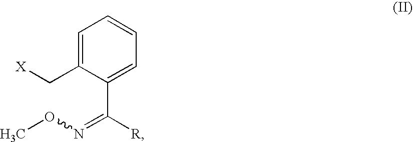
in which
R is as defined in claim 1 and
X represents halogen
are reacted with a substituted phenol of the general formula (III) 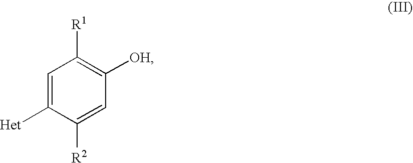
in which
R¹, R² and Het are as defined above,
if appropriate in the presence of a diluent and if appropriate in the presence of an acid acceptor, or
b) compounds of the formula (I) where R is methoxycarbonyl are reacted with methylamine, if appropriate in the presence of a diluent, or
c) compounds of the general formula (IV) 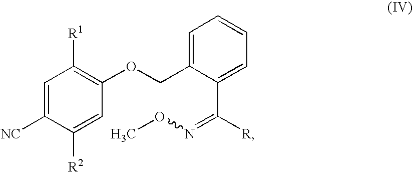
in which
R, R¹ and R² are as defined above
are reacted with an alkali metal azide, if appropriate in the presence of a diluent, or
d) heterocyclylphenyl benzyl ethers of the formula (I) where Het is tetrazolyl are reacted with alkylating agents, such as, for example, iodomethane, dimethyl sulfate or bromoethane, if appropriate in the presence of a diluent and if appropriate in the presence of an acid acceptor.

8. A composition for controlling harmful organisms, which composition comprises extenders and/or carriers and optionally surfactants, characterized in that the composition comprises at least one compound as defined in any of claims 1 to 3.

9. A method for controlling harmful organisms, characterized in that compounds as defined in any of claims 1 to 3 or compositions as defined in claim 8 are allowed to act on harmful organisms and/or their habitat.

10. The use of compounds as defined in any of claims 1 to 3 or of compositions as defined in claim 8 for controlling harmful organisms.

11. A process for preparing compositions as defined in claim 8, characterized in that compounds as defined in any of claims 1 to 3 are used with extenders and/or carriers and/or surfactants.
